(19) United States
(12) Patent Application Publication
(10) Pub. No.: US 2025/0386113 A1
(43) Pub. Date: Dec. 18, 2025

(54) AN EVENT BASED VISION SENSOR FOR FLICKER ENVIRONMENT DETECTION AND DTECTING METHOD THEREOF

(71) Applicant: HUAWEI TECHNOLOGIES CO., LTD., Shenzhen, Guangdong (CN)

(72) Inventors: Shiroshi KANEMITSU, Tokyo (JP); Makoto MONOI, Tokyo (JP); Kewei JIANG, Shanghai (CN)

(21) Appl. No.: 18/867,564

(22) PCT Filed: Jul. 30, 2022
(86) PCT No.: PCT/CN2022/109279

§ 371 Date: Nov. 20, 2024

(51) Int. Cl. H04N 25/47; H04N 23/745

(52) U.S. Cl. CPC H04N 25/47; H04N 23/745

(57) ABSTRACT

An event-based vision sensor (EVS) is provided. The EVS includes an EVS panel that includes a pixel array, a window counter unit, an on/off counter unit, and an Identification of Condition (IoC) unit. The window counter unit partitions the pixel array into a plurality of windows. The on/off counter unit counts on-events and off-events occurring for each window in the plurality of windows. The IoC unit determines whether to mask each of the corresponding windows in accordance with the count.

### CROSS-REFERENCE TO RELATED APPLICATIONS

This application is a national stage of International Application No. PCT/CN2022/109279 filed on Jul. 30, 2022, which is hereby incorporated by reference in its entirety.

### TECHNICAL FIELD

The present disclosure relates to an imaging device, and more particularly to an event vision sensor with enhanced flicker environment detection. The event vision sensor (EVS) can be employed in camera system.

### BACKGROUND

An event-based vision sensor (EVS) is a sensor that detects the luminance change of each pixel in an image sensor and outputs only the changed data. The EVS simulates the mechanism of human eyes, which sense the light, providing high-speed and low-latency data output. With recent advances in image processing technology, EVS has come to be used, for example, in a vision system of automotive vehicle operation.

The EVS operates as follows (refer to FIG. 1). A photodetector of the sensor converts the linear current output of the Photo Diode section into a log voltage in response to the intensity of the incident light. An amplifier detects the difference between the input voltage and the reset voltage. A comparator detects and outputs an ON event or an OFF event when the input difference reaches to a preset threshold value for the ON event or the OFF event. When the ON event or the OFF event are output, the threshold value is updated.

That is, when a voltage change due to the incident light exceeds the threshold value of the positive side from the reference voltage (e.g., the change to brighter direction), “1” is output as an on-event (e.g., the ON event). On the other hand, when the voltage change exceeds the threshold value of the negative side from the reference voltage (e.g., the change to darker direction), “−1” is output as an off-event (e.g., the OFF event). When an event occurs, the threshold level is reset so that the luminance level at that point in time becomes the baseline. If the voltage change due to the incident light does not exceed both thresholds, “0” is output as null event.

These operations allow the EVS to provide high-speed and low-latency data output. However, under indoor using fluorescent lighting, the EVS responds to flicker of the fluorescent and them output the event. This renders it impossible to capture the behavior of a moving object that essentially needs to be observed.

The flicker environment has been recognized as a problem even in conventional image sensors before the advent of the EVS. In conventional sensors such as a charge-integration type sensor with a rolling shutter system, such as the conventional sensor, a phenomenon known as the “row band” occurs due to differences in exposure timing.

### SUMMARY

This disclosure provides an EVS that can be used in the flicker environment, so that the camera system employing the EVS can cancel event signals generated by the flicker of light and output signals caused by moving objects captured in pixels.

According to a first aspect, an embodiment of the present disclosure provides event-based vision sensor (EVS). The EVS comprises an EVS panel consisting of a pixel array, wherein each pixel in the pixel array generates on-event or off-event in response to a comparison of an output of sensor signal and a threshold.

And the EVS comprises the EVS panel, a window counter unit, an on/off counter unit, and an Identification of Condition (IoC) unit. The window counter unit divides the pixel array into a plurality of windows, the on/off counter unit counts on-events and off-events occurring for each window in the plurality of windows, and the IoC unit determines whether to mask each of the corresponding windows in accordance with the count.

With reference to the first aspect, in one possible implementation, the IoC unit is configure to, in case of the count is one or more on-events in succession or the count is one or more off-events in succession, determine that the corresponding window is a flicker window and mask the window, and in case of on-events and off-events are mixed in the count, determine that the corresponding window is a non-flicker window and let the sensor signal to be output from each pixel in the window.

With reference to the first aspect, in one possible implementation, the IoC unit is further configure to, in case of one or more on-events in succession and one or more off-events in succession continue in the count, determine that the corresponding window is a flicker window.

With reference to the first aspect, in one possible implementation, the EVS further comprising a flicker detection (FD) unit. And the FD unit is configured to count the on-events and the off-events to be output from the on/off counter unit, increment the count in case of the on-event, decrement the count in case of the off-event, and, when the count exceeds a threshold value, determine that the corresponding window is a flicker window, and output a result of the determination.

With reference to the first aspect, in one possible implementation, the IoC unit is further configured to, in case of both on-event and off-event occur simultaneously, output a signal. And the EVS is configured to calculate a logical sum of the signal and the result of the determination output from the FD, determine that the corresponding window is a non-flicker window according to the logical sum, and let the sensor signal to be output from each pixel in the window.

With reference to the first aspect, in one possible implementation, the EVS further comprising a frequency calculation block. And the frequency calculation block is configured to calculate a flicker frequency based on a signal output from the IoC unit identifying the on-event and the off-event and a frame rate in operation.

With reference to the first aspect, in one possible implementation, the frequency calculation block is further configured to compare the calculated flicker frequency with a preset frequency. And the EVS is configured to determine whether to mask each window in accordance with a result of the comparison.

According to a second aspect, an embodiment of the present disclosure provides a camera system comprising any one of the EVS of possible implementations according to the first aspect described above.

According to a third aspect, an embodiment of the present disclosure provides a method of detecting a flicker environment using an event-based vision sensor (EVS), where each pixel in a pixel array consisting of the EVS panel generates on-event or off-event in response to a comparison of an output of sensor signal and a threshold. The method comprises one or more operations of dividing the pixel array into a plurality of windows, one or more operations of counting on-events and off-events occurring for each window in the plurality of windows, and one or more operations, in case of the count is one or more on-events in succession or the count is one or more off-events in succession, of determining that the corresponding window is a flicker window and detecting the flicker environment.

With reference to the third aspect, in one possible implementation, the method further comprises one or more operations, in case of one or more on-events in succession and one or more off-events in succession continue in the count, of determining that the corresponding window is a flicker window and detecting the flicker environment.

### BRIEF DESCRIPTION OF THE ACCOMPANYING DRAWINGS

In order to more clearly describe embodiments of the present disclosure, the accompanying drawings as required will be briefly described below. Obviously, in the following description, the accompanying drawings show only some embodiments of the present disclosure, and even other drawings from these accompanying drawings can be drawn by a skilled person in the art without creative effort.

FIG. 1 illustrates the operation of EVS in the prior art.

FIG. 2 is a schematic diagram for change of luminance in a flicker environment.

FIG. 3 illustrates the operation of EVS in the flicker environment.

FIG. 4 shows a pixel array window according to the present disclosure.

FIG. 5 shows characteristics of an event caused by the flicker and by a moving object in a window.

FIG. 6 is a block diagram showing a first embodiment of the present disclosure.

FIG. 7 shows a table used in an Identification of Condition (IoC) unit in FIG. 6.

FIG. 8 summarizes the operations according to the first embodiment of the present disclosure.

FIG. 9 is a block diagram showing a second embodiment of the present disclosure.

FIG. 10 shows an operation in a flicker detection (FD) unit to determine whether it is under the flicker environment.

FIG. 11 is a block diagram showing a third embodiment of the present disclosure.

FIG. 12 shows an operation to determine whether to mask a window under the flicker environment.

FIG. 13 is a block diagram showing a fourth embodiment of the present disclosure.

FIG. 14 is a block diagram showing a fifth embodiment of the present disclosure.

FIG. 15 is a block diagram showing a sixth embodiment of the present disclosure.

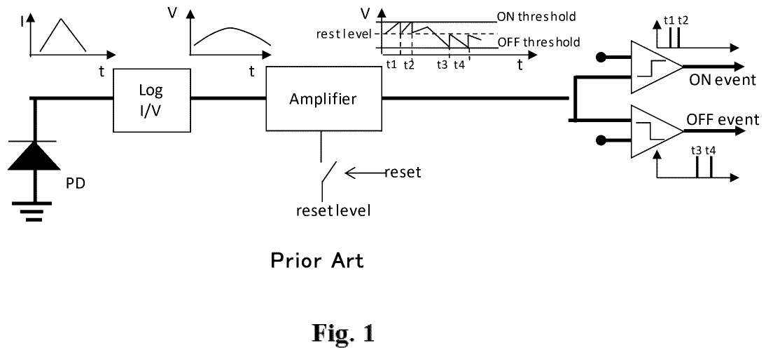

### DETAILED DESCRIPTION

Hereinafter, embodiments according to the present disclosure will be described in detail with reference to the drawings.

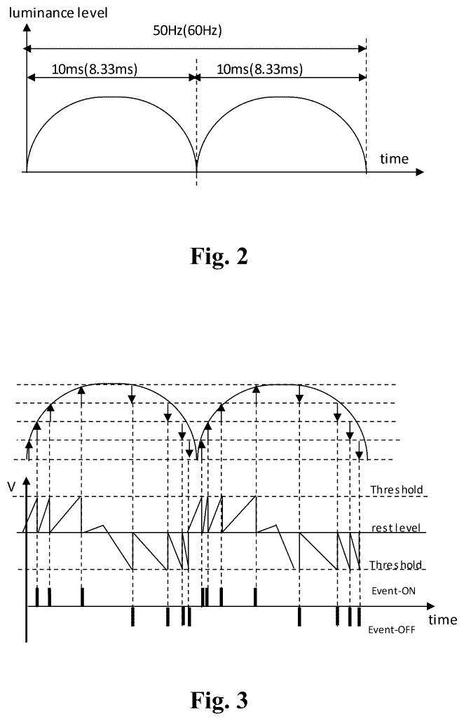

FIG. 2 is a schematic diagram for change of luminance in a flicker environment. For example, in a 50 Hz AC power operating environment, the fluorescent lighting indicates a luminance change of 10 ms period which is similar to a sinusoidal wave.

FIG. 3 illustrates the operation of the EVS in the flicker environment. In the top row, the size and direction of the luminance change causing the event are represented by arrows in the locus of sinusoidal luminance shown in FIG. 2. The middle row shows the relationship between the luminance change and the threshold, and the bottom row shows the resulting event output.

In the top raw of FIG. 3, the most left-hand arrow represents the luminance change that causes the first event. This luminance change is a change in a brighter direction, e.g., the change of luminance resulting an on-event. The length of the arrow indicates the magnitude of the luminance change from the reset level shown in the middle row until the threshold is reached. As shown in the bottom row, as the flicker progresses, the level of luminance gets higher, and the first on-event occurs when the magnitude of the luminance change reaches the threshold, outputting a “1”. When an event occurs, level of the threshold is reset at that time. Then, as the flicker progresses and the level of luminance becomes even higher, a second on-event occurs when the magnitude of the luminance change reaches the threshold. Similarly, subsequent on-events have occurred. In other words, “1” is output as much as the number of on-events that have occurred.

During the period of time before and after the peak of the sinusoidal wave of the luminance change, e.g., the period of time that the luminance changes from brighter direction to darker direction, does not occur because the magnitude of the luminance change is less than the threshold value. Therefore, “0” is output as no event.

Then, after the peak of the sinusoidal wave of the luminance change, when the flicker changes in the dark, that is, when the luminance change causes an off-event, similarly to the above on-event, the level of luminance decreases as the flicker progresses, and the first off-event occurs when the magnitude of the luminance change reaches a threshold and outputs “−1”. When an event occurs, the level is reset at that time. Then, as flicker progresses and the level of luminance falls further, a second off-event occurs when the magnitude of the luminance change reaches a threshold. Similarly, subsequent off-events have occurred. In other words, “−1” is output as much as the number of off-events that have occurred.

Thus, in the flicker environment, the on-event occurs one or more consecutive times, or the off-event occurs one or more consecutive times, depending on the flicker cycle.

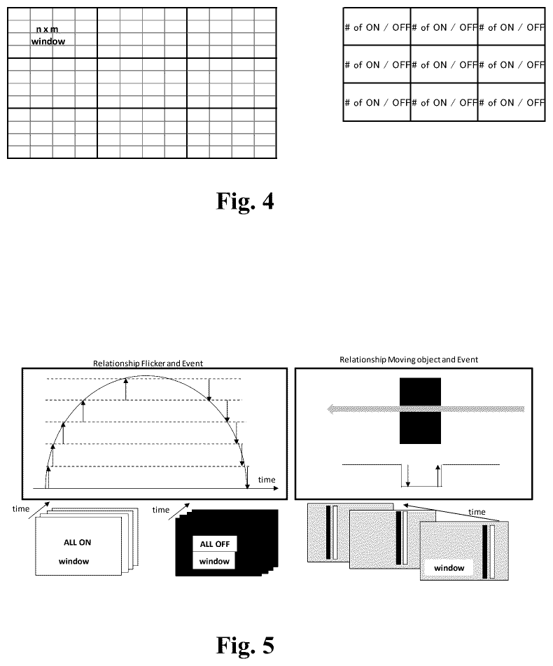

FIG. 4 illustrates the pixel array window according to the present disclosure. The sensor portion of the EVS consists of a pixel array. In the present disclosure, the pixel array is divided into arbitrary number of windows, e.g., n×m window arrays. In FIG. 4, for example, 12×12 pixel array is divided into 3×3 windows. For each window, the number of on-events or off-events occurring on the pixels in the window is then counted, respectively.

FIG. 5 shows the characteristics of an event caused by the flicker and by a moving object in a window. The left diagram shows events in a certain window under the flicker environment, in which, over time, that is, responding to the progress of the frame, a window in which all are on-events occurs in consecutive multiple times, and then a window in which all are off-events follows in consecutive multiple times. On the other hand, in the right diagram, an object moves from the right direction to the left direction, and the moving object is captured in the window. In this case, an on-event and an off-event occur at both edges of the object, and locations of the on-event and the off-event move from right to left over time, that is, as the frame progresses. Thus, the way in which events occur differs significantly between windows that capture the moving object as a target to be observed and windows in the flicker environment.

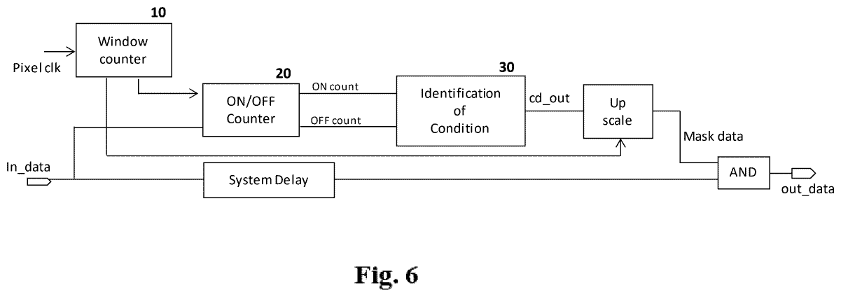

FIG. 6 is a block diagram showing the first embodiment of the present disclosure. In the first embodiment, the EVS includes a window counter unit 10, an on/off counter unit 20, and an Identification of Condition (IoC) unit 30. The window counter unit 10 divides the pixel array into arbitrary window sizes (e.g., n×m matrices), and the on/off counter unit 20 counts on-events and off-events that occur for each window. When the count is completed, the on/off counter unit 20 outputs the result of the count to the IoC unit 30. As the output, if there are on-events in one or more consecutive times, then ON count is 1, otherwise the ON count is 0. Alternatively, as the output, if there are off-events in one or more consecutive times, then OFF count is 1, otherwise the OFF count is 0. The IoC unit 30 masks each window according to the value of each count, that is, determines whether to prohibit the sensor output (In data) of pixels in the window, or whether to enable the sensor output of pixels in the window (cd_out).

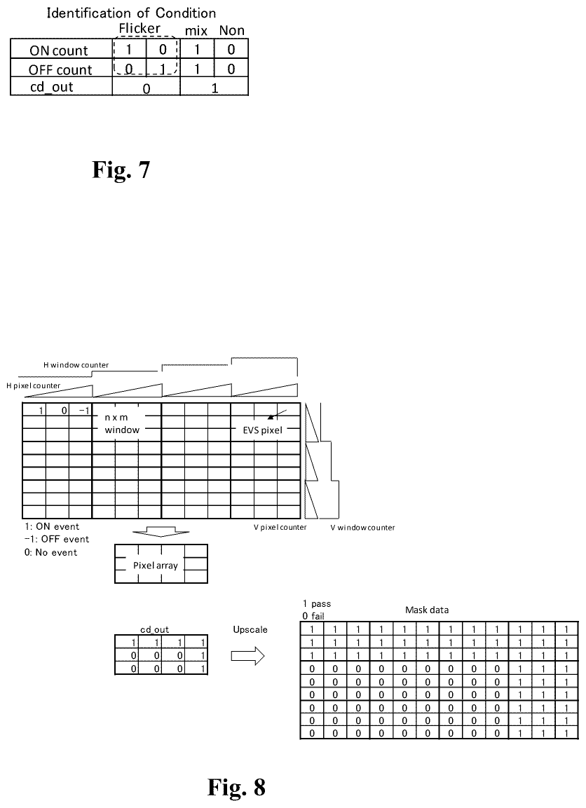

The above described decision is made based on the table shown in FIG. 7 as follows.
When the ON count is 1 and the OFF count is 0, it is determined to be under the flicker environment, and output cd_out with value of 0 to mask the output of the corresponding window.
When the ON count is 0 and the OFF count is 1, also it is determined to be under the flicker environment, and output cd_out with value of 0 to mask the output of the corresponding window.
When the ON count is 1 and the OFF count is 1, it is determined not to be under the flicker environment, and output cd_out with value of 1 to enable the output of the corresponding window.
When the ON count is 0 and the OFF count is 0, also it is determined not to be under the flicker environment, and output cd_out with value of 1 to enable the output of the corresponding window.

FIG. 8 summarizes the above operations. Finally, for a window in which cd_out having value of 1, the sensor output is enabled for each pixel in the window. Thereby, even under the flicker environment, it is possible to detect the moving object as a target to be observed by using the event-based vision sensor (EVS).

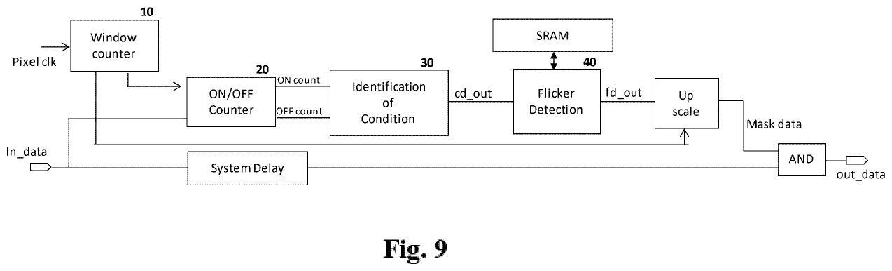

FIG. 9 is a block diagram showing the second embodiment of the present disclosure. In the second embodiment, a flicker detection (FD) unit 40 is added to the block diagram of the EVS according to the first embodiment shown in FIG. 6. The input to the FD unit 40 is cd_out from the IoC unit 30, and the FD unit 40 outputs fd_out as a result of the flicker detection determination. When it is determined to be under the flicker environment Fd_out is 0, and if it is determined not to be in the flicker environment Fd_out is 1.

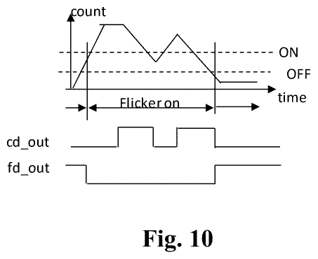

The FD 40 adds hysteresis characteristics to determine whether it is under the flicker environment, so that the flicker detection is robust against the temporary changes in the external environment. In the FD unit 40, for each frame, the number of times that is determined to be under the flicker environment in each window is stored in the SRAM and counted. In one embodiment, as shown in FIG. 10, the count is incremented during the period determined to be in the flicker environment (e.g., cd_out is 0) and it is decremented during the period determined not to be in the flicker environment (e.g., cd_out is 1). Then, by setting a threshold value for the count number, for a period in which the count number exceeds on-threshold, it is determined to be in the flicker environment and output fd_out with value of 0. While, for a period in which the count number falls below the off-threshold, it is determined not to be in the flicker environment and output fd_out with value of 1. Thereby, for the period in which the count exceeds the on-threshold, even if cd_out becomes 1 during the period, this can be recognized as the temporary change in the external environment assuming that the flicker environment is generally continuing, and then fd_out remains 0. In the example shown in FIG. 10, when the second time cd_out becomes 1 and the decremented count number falls below the off-threshold value, it is determined not to be in the flicker environment, and fd_out is changed from 0 to 1. In this manner, robustness can be added to the flicker detection. The desired robustness can be obtained by adjustment of setting for the on-threshold and off-threshold.

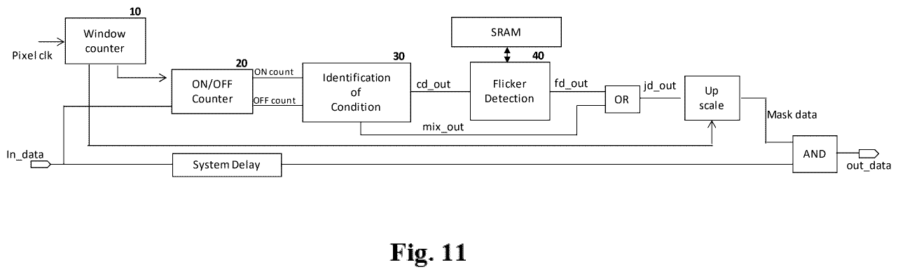

FIG. 11 is a block diagram showing a third embodiment of the present disclosure. The third embodiment is intended to add further rapidity to the EVS according to the above-described second embodiment with added robustness. In one embodiment, in the third embodiment, in the block diagram of the EVS according to the second embodiment shown in FIG. 9, a block for logical determination is added, in which a logical sum (e.g., OR) of fd_out as the output from the FD unit 40 and mix_out as a new output from the IoC unit 30 is taken.

As described above with respect to FIG. 5, when the moving object is captured in a window, on-event and off-event occur at both edges of the object. That is, the on-event and the off-event occur simultaneously in the same window, and the ON count with value of 1 and the OFF count with value of 1 are output from the on/off counter unit 20 simultaneously. In such a case, even if the window is determined to be a flicker window (e.g., being under the flicker environment), the determination may change to be a non-flicker window so that the sensor output caused by the moving object should be enabled. Therefore, in the third embodiment, mix_out is added as the output from the IoC unit 30.

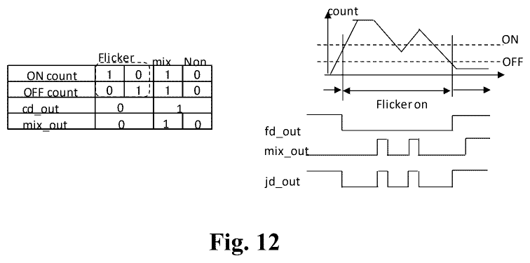

The table in the left side of FIG. 12 illustrates the output of the IoC unit 30 according to the third embodiment. When compared with the table above shown in FIG. 7, it can be seen that mix_out is prepared in addition to cd_out as the output from the IoC unit 30. The value of Mix_out is 1 only when the ON count is 1 and the OFF count is concurrently, and the value of mix_out is 0 in other cases. In other words, the mix_out with value of 1 indicates that the moving object is captured in the window.

In the third embodiment, a logical sum (OR) of mix_out as a new output from the IoC unit 30 and fd_out as the output of the FD unit 40 is taken, and jd_out is output, thereby controlling whether to mask the window. It can be understood from the chart in the right side of FIG. 12 that even in the period determined to be in the flicker environment (fd_out is 0), for the period having mix_out with value of 1, jd_out becomes 1, and for that period, assuming that it is the non-flicker window, the sensor output caused by the moving object is enabled. In this way, robustness can be added to the determination of whether the object is in the flicker environment, and then a quick response can be obtained even when the moving object is captured.

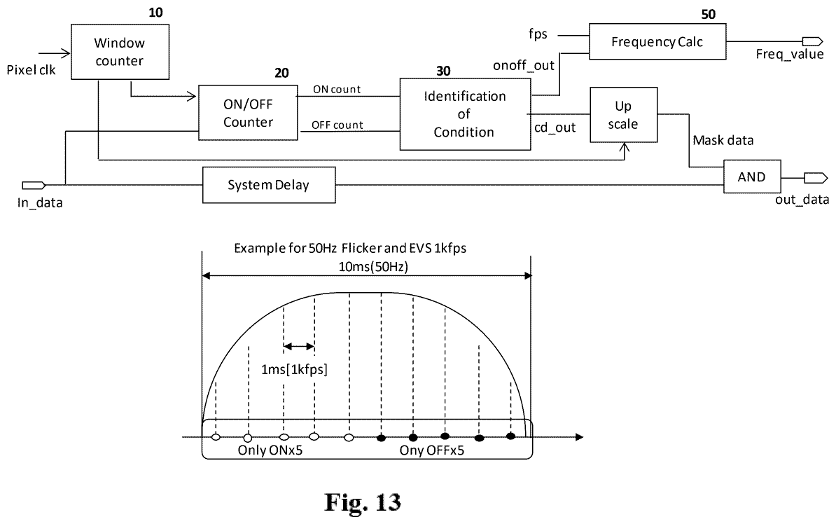

FIG. 13 is a block diagram showing the fourth embodiment of the present disclosure. In the fourth embodiment, a frequency calculation block 50 is added in the first embodiment described above, and a flicker frequency can be calculated.

The frequency calculation block 50 in the fourth embodiment calculates a frequency by using a frame rate fps (frames per second) and onoff_out signal as input, and outputs a frequency Freq_value. Where onoff_out is the signal identifying the on-event and the off-event. As shown in the lower chart of FIG. 13, when the frame rate is 1 kfps (kilo frames per second), then the frame interval is 1 msec, and when 5 consecutive off-events further occur after the occurrence of 5 consecutive on-events, the flicker frequency can be calculated to be 50 Hz. As such, this not only allows motion detection under the flicker environment, but also allows identification of frequency of the flicker.

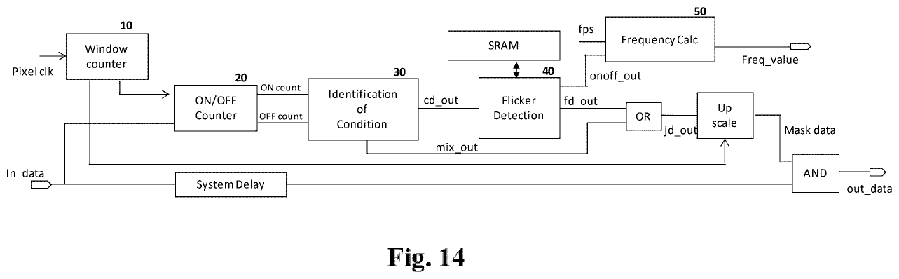

FIG. 14 is a block diagram showing a fifth embodiment of the present disclosure. In the fifth embodiment, a frequency calculation block 50 is added in above described second embodiment or third embodiment. In FIG. 14, the frequency calculation block 50 is added to the third embodiment.

As described above, in the second embodiment or the third embodiment, robustness is added to the flicker detection, so it is expected that more robust flicker frequency can be obtained in the fifth embodiment compared to the fourth embodiment.

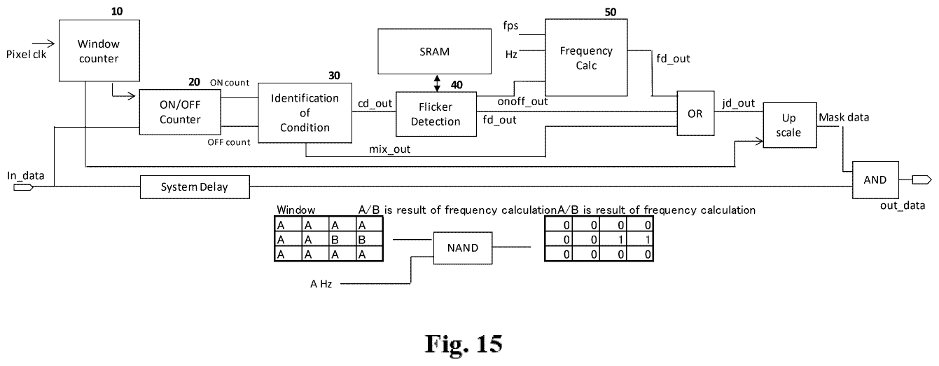

FIG. 15 is a block diagram showing the sixth embodiment of the present disclosure. In the sixth embodiment, the flicker frequency calculated in above described fourth or fifth embodiment is compared to a preset frequency.

In the sixth embodiment, a preset frequency Hz is added as an input to the frequency calculation block 50. As shown in the lower part of FIG. 15, for example, when the preset frequency is A[Hz] and when a window exists in which the calculated frequency is B[Hz], only the flicker of the specified frequency can be removed by taking a negative logic product (NAND) of the preset frequency value and the calculated frequency value for each window, and then masking the window in which the result of NAND is 1.

By using the EVS according to the present disclosure, it is possible to provide a camera system capable of acquiring high image quality without loss of pixel number. Further, a small size of image rotation correction mechanism can be realized in accordance with the present disclosure.

By using the EVS according to the present disclosure, it is possible to provide a flicker detection method capable of acquiring high image quality without loss of pixel number. Further, a small size of image rotation correction mechanism can be realized in accordance with the present disclosure.

The above-described embodiments provided by this disclosure, however, it is not intended to limit the present disclosure. Any modification, equivalent substitution, or improvement made without departing from the spirit and principle of the present disclosure is to be included within the scope of protection of this application.

### DESCRIPTION OF SYMBOLS

10: Window Counter
20: ON/OFF Counter
30: Identification of Condition
40: Flicker Detection
50: Frequency Calculation

1-10. (canceled)

11. An event-based vision sensor (EVS), comprising:
an EVS panel comprising a pixel array, wherein each pixel in the pixel array generates an on-event or an off-event in response to a comparison of an output of sensor signal and a threshold;
a window counter unit that partitions the pixel array into a plurality of windows;
an on/off counter unit that counts on-events and off-events occurring for each window of the plurality of windows; and
an Identification of Condition (IoC) unit that determines whether to mask each of the corresponding windows in accordance with the count.

12. The EVS according to claim 11, wherein the IoC unit is configured to:
determine that the corresponding window is a flicker window and mask the window when at least one of:
the count is one or more of the on-events in succession; or
the count is one or more of the off-events in succession; and
determine that the corresponding window is a non-flicker window and let the sensor signal be output from each pixel in the window when the on-events and the off-events are mixed in the count.

13. The EVS according to claim 12, wherein the IoC unit is further configure to:
determine that the corresponding window is a flicker window when one or more of the on-events in succession and one or more of the off-events in succession continue in the count.

14. The EVS according to claim 13, further comprising:
a flicker detection (FD) unit configured to:
count the on-events and the off-events that are output from the on/off counter unit;
increment the count in case of the on-event;
decrement the count in case of the off-event; and
when the count exceeds a threshold value, determine that the corresponding window is a flicker window and output a result of the determination.

15. The EVS according to claim 14, wherein the IoC unit is further configured to:
output a signal when both the on-event and the off-event occur simultaneously, and wherein, the EVS is configured to:
calculate a logical sum (OR) of the signal and the result of the determination output from the FD; and
determine that the corresponding window is a non-flicker window and let the sensor signal to be output from each pixel in the window according to the logical sum.

16. The EVS according to claim 12, further comprising:
a frequency calculation block configured to:
calculate a flicker frequency based on a signal output from the IoC unit identifying the on-event and the off-event and a frame rate in operation.

17. The EVS according to claim 16, wherein
the frequency calculation block is further configured to:
compare the calculated flicker frequency with a preset frequency; and
the EVS is configured to:
determine whether to mask each window in accordance with a result of the comparison.

18. A camera system, comprising:
an event-based vision sensor (EVS), the EVS comprising:
an EVS panel comprising a pixel array, wherein each pixel in the pixel array generates on-event or off-event in response to a comparison of an output of sensor signal and a threshold,
a window counter unit that partitions the pixel array into a plurality of windows,
an on/off counter unit that counts on-events and off-events occurring for each window of the plurality of windows; and
an Identification of Condition (IoC) unit that determines whether to mask each of the corresponding windows in accordance with the count.

19. The camera system according to claim 18, wherein the IoC unit is configured to:
determine that the corresponding window is a flicker window and mask the window when at least one of:
the count is one or more of the on-events in succession; or
the count is one or more of the off-events in succession; and
determine that the corresponding window is a non-flicker window and let the sensor signal to be output from each pixel in the window when the on-events and the off-events are mixed in the count.

20. The camera system according to claim 19, wherein the IoC unit is further configure to:
determine that the corresponding window is a flicker window when one or more of the on-events in succession and one or more of the off-events in succession continue in the count.

21. The camera system according to claim 20, further comprising:
a flicker detection (FD) unit configured to:
count the on-events and the off-events that are output from the on/off counter unit;
increment the count in case of the on-event;
decrement the count in case of the off-event; and
when the count exceeds a threshold value, determine that the corresponding window is a flicker window and output a result of the determination.

22. The camera system according to claim 21, wherein
the IoC unit is further configured to:
output a signal when both the on-event and the off-event occur simultaneously; and
the EVS is configured to:
calculate a logical sum (OR) of the signal and the result of the determination output from the FD; and
determine that the corresponding window is a non-flicker window and let the sensor signal to be output from each pixel in the window according to the logical sum.

23. The camera system according to claim 19, further comprising:
a frequency calculation block configured to:
calculate a flicker frequency based on a signal output from the IoC unit identifying the on-event and the off-event and a frame rate in operation.

24. The camera system according to claim 23, wherein
the frequency calculation block is further configured to:
compare the calculated flicker frequency with a preset frequency, and
the EVS is configured to:
determine whether to mask each window in accordance with a result of the comparison.

25. A method of detecting a flicker environment using an event-based vision sensor (EVS) that includes an EVS panel comprising a pixel array, the method comprising:
partitioning the pixel array into a plurality of windows, wherein each pixel in the pixel array generates an on-event or an off-event in response to a comparison of an output of sensor signal and a threshold;
counting the on-events and the off-events occurring for each window of the plurality of windows; and
determining that the corresponding window is a flicker window when at least one of:
the count is one or more of the on-events in succession; or
the count is one or more of the off-events in succession; and
detecting the flicker environment.

26. The method according to claim 25, further comprising:
determining that the corresponding window is a flicker window when one or more of the on-events in succession and one or more of the off-events in succession continue in the count; and
detecting the flicker environment.

27. The method according to claim 26, further comprising:
counting the on-events and the off-events that are output from the on/off counter unit;
incrementing the count in case of the on-event;
decrementing the count in case of the off-event; and
when the count exceeds a threshold value, determining that the corresponding window is a flicker window and output a result of the determination.

28. The method according to claim 27, further comprising:
outputting a signal when both the on-event and the off-event occur simultaneously;
calculating a logical sum (OR) of the signal and the result of the determination output from the FD; and
determining that the corresponding window is a non-flicker window and let the sensor signal to be output from each pixel in the window according to the logical sum.

29. The method according to claim 25, further comprising:
calculating a flicker frequency based on a signal output from the IoC unit identifying the on-event and the off-event and a frame rate in operation.

30. The method according to claim 29, further comprising:
comparing the calculated flicker frequency with a preset frequency; and
determining whether to mask each window in accordance with a result of the comparison.
